(19) United States
(12) Patent Application Publication
(10) Pub. No.: US 2006/0139306 A1
(43) Pub. Date: Jun. 29, 2006

(54) electrophoretic display panel

(76) Inventors: Mark Thomas Johnson, EINDHOVEN (NL); Alexander Victor Henzen, Heerlen (NL); Hugo Johan Cornelissen, Eindhoven (NL); Guofu Zhou, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/543,435

(22) PCT Filed: Jan. 13, 2004
(86) PCT No.: PCT/IB04/50017

§ 371 Date: Jul. 26, 2005

(30) Foreign Application Priority Data
Jan. 30, 2003 (EP) 03100189.4

(51) Int. Cl. G09G 3/34

(52) U.S. Cl. 345/107

(57) ABSTRACT

The electrophoretic display panel (1) for displaying a picture corresponding to image information has drive means (100) which are able to control for each picture element (2) the potentials, thereby being able to change the position of the particles (6) based on the image information. Furthermore, the display panel (1) has monitoring means (101) which are able to generate for each picture element (2) actual position information indicative for the actual position of the particles (6), and control means (103) which are able to control for each picture element (2) the drive means (100) in dependence of the actual position information and the image information to reduce a difference between the position of the particles (6) and the position off the particles (6) corresponding to the image information. For the display panel (1) to be able to provide a picture of relatively high quality even at relatively low or nonuniform intensities of the ambient light, the monitoring means (101) comprise electrical means (102) which are able to generate for each picture element (2) the actual position information based on an electrical property of the respective picture element (2).

The invention relates to an electrophoretic display panel for displaying a picture corresponding to image information, comprising:
an electrophoretic medium, comprising charged particles in a fluid;
a plurality of picture elements;
a first and a second electrode associated with each picture element for receiving a first and a second potential, respectively,
drive means;
monitoring means; and
control means,
   the charged particles being able to occupy a position between the electrodes, the drive means being able to control for each picture element the potentials, thereby being able to change the position of the particles based on the image information,
   the monitoring means being able to generate for each picture element actual position information indicative for the actual position of the particles, and
   the control means being able to control for each picture element the drive means in dependence of the actual position information and the image information to reduce a difference between the actual position of the particles and the position of the particles corresponding to the image information.

An embodiment of the electrophoretic display panel of the type mentioned in the opening paragraph is described in non-prepublished European Patent application 02077045.9 (PHNL020386).

In electrophoretic display panels in general, the picture elements have, during the display of the picture, appearances determined by the positions of the charged particles between the electrodes. The positions of the particles depend, however, not only on the potentials but also on the history of the potentials. As a result, the picture being displayed corresponding to the image information differs significantly from an exact representation of the image information. Therefore, the picture being displayed has a relatively low quality. The dependency on the history is reduced in the described electrophoretic display panel in the following way. The monitoring means, comprising a photo sensor in each picture element, register the intensity of ambient light penetrated into each picture element. The level of absorption of the ambient light depends on the position of the particles. The monitoring means also register the intensity of ambient light falling onto the display panel and comprise to that end a plurality of photo sensors arranged around the periphery of the display panel. If the registered intensity of the ambient light penetrated into each picture element is compared with the registered intensity of the ambient light falling onto the display panel, the registered intensity of each picture element is indicative for the actual position of the particles in each picture element. The control means control for each picture element the drive means in dependence of the registered intensities and the image information to reduce the difference between the actual position of the particles and the position of the particles corresponding to the image information. As a result, the difference between the actual picture on the display panel and the intended picture on the display panel, being an exact representation of the image information, is relatively small. Therefore, the actually displayed picture has a relatively high quality. However, at relatively low or non-uniform intensities of the ambient light, the photo sensors inaccurately register the intensity of the ambient light. As a result, the actually displayed picture then has a rather poor picture quality.

It is a drawback of the described display panel that the actually displayed picture has a rather poor quality at relatively low or non-uniform intensities of the ambient light.

It is an object of the invention to provide a display panel of the kind mentioned in the opening paragraph which is able to provide a picture of relatively high quality even at relatively low or non-uniform intensities of the ambient light.

The object is thereby achieved that the monitoring means comprise electrical means able to generate for each picture element the actual position information based on an electrical property of the respective picture element.

The invention is based on the insight that, if, for each picture element, the actual position information is based on an electrical property of the respective picture element, the actual position information obtained is independent of the intensity of the ambient light.

The electrical property may for instance be the electrical resistance between the first and the second electrode as the electrical conductivity of the particles is different than the electrical conductivity of the fluid. Therefore, the electrical resistance depends on the position of the particles. Therefore, in an embodiment, the electrical means are able to generate for each picture element the actual position information based on an electrical resistance between the first and the second electrode. However, a value of the resistance may relate to two different positions of the particles. As an example, the particles occupying a position near the first electrode may correspond to the same value of the resistance as the particles occupying a position near the second electrode. Monitoring of the actual position of the particles by means of the electrical resistance can be improved by a combination of the electrical resistance and a function of a derivative of the resistance with respect to the position of the particles in the picture element. Therefore, in an embodiment, the electrical means are able to generate for each picture element the actual position information based on an electrical resistance between the first and the second electrode and a function of a derivative of the resistance with respect to the position of the particles of the respective picture element. In a variation, the function is a sign function, being positive for a positive value, zero for a zero value and negative for a negative value, which can relatively easy be determined.

In another embodiment the electrical means are able to generate for each picture element the actual position information based on a capacitance between the first electrode and the second electrode, as the capacitance depends on the position of the charged particles as the particles and the fluid have different dielectric constants. However, a value of the capacitance may relate to two different positions of the particles. As an example, the particles occupying a position near the first electrode may correspond to the same value of the capacitance as the particles occupying a position near the second electrode. Monitoring of the actual position of the particles by means of the capacitance can be improved by a combination of the capacitance and a function of a derivative of the capacitance with respect to the position of the particles in the picture element. Therefore, in an embodiment the electrical means are able to generate for each picture element the actual position information based on a capacitance between the first and the second electrode and a function of a derivative of the capacitance with respect to the position of the particles of the respective picture element. In a variation, the function is a sign function, which can relatively easy be determined.

These and other aspects of the display panel of the invention will be further elucidated and described with reference to the drawings, in which:

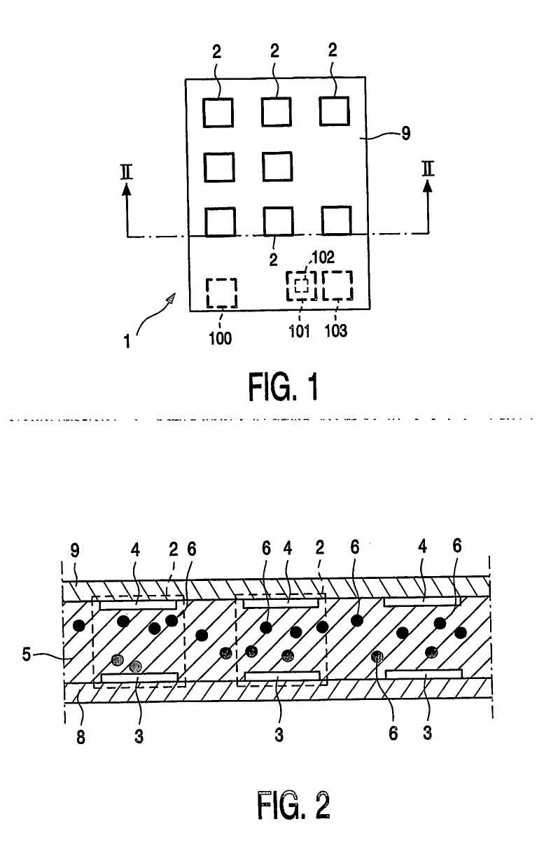

FIG. 1 shows diagrammatically a front view of an embodiment of the display panel;

FIG. 2 shows diagrammatically a cross-sectional view along II-II in FIG. 1;

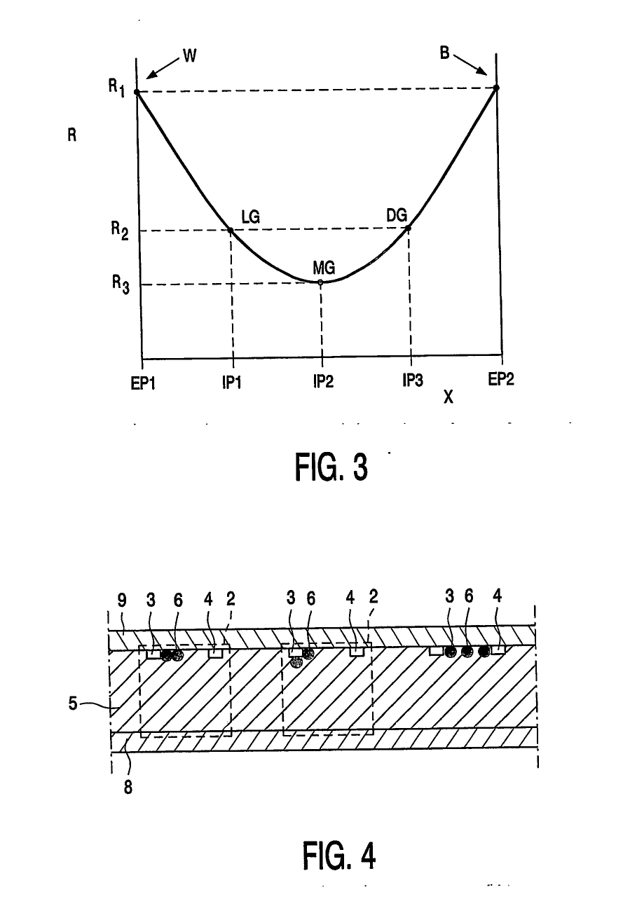

FIG. 3 shows in a graphical form the relation between the position X of the particles and the electrical resistance R;

FIG. 4 shows diagrammatically a cross-sectional view along II-II in FIG. 1 of a second embodiment;

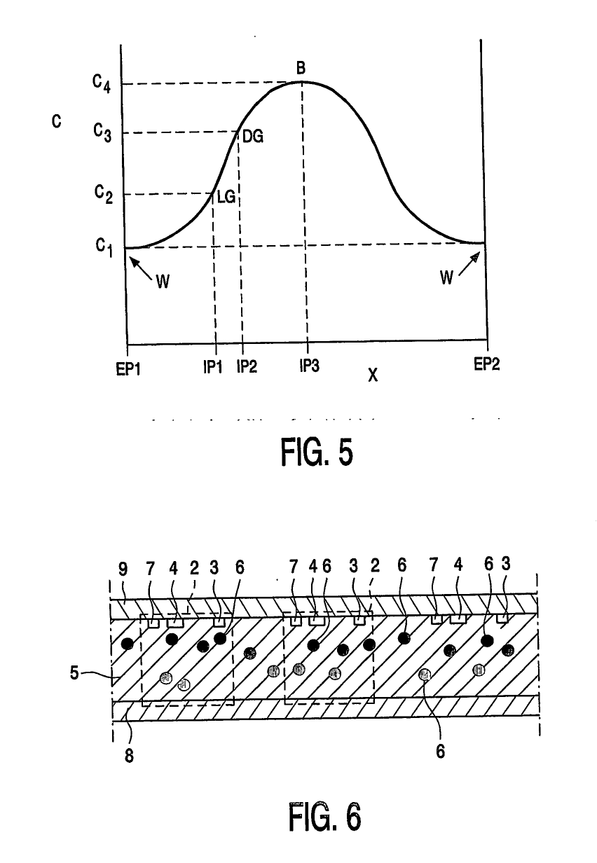

FIG. 5 shows in a graphical form the relation between the position X of the particles and the capacitance C; and

FIG. 6 shows diagrammatically a cross-sectional view along II-II in FIG. 1 of a third embodiment; and

In all the Figures corresponding parts are referenced to by the same reference numerals.

FIGS. 1 and 2 show the embodiment of the display panel 1 having a first substrate 8, a second opposed substrate 9 and a plurality of picture elements 2. Preferably, the picture elements 2 are arranged along substantially straight lines in a two-dimensional structure. Other arrangements of the picture elements 2 are alternatively possible, e.g. a honeycomb arrangement. An electrophoretic medium 5, having charged particles 6 in a fluid, is present between the substrates 8,9. A first and a second electrode 3,4 are associated with each picture element 2 for receiving a first and a second potential, respectively. In FIG. 2 the first substrate 8 has for each picture element 2 a first electrode 3, and the second substrate 9 has for each picture element 2 a second electrode 4. The charged particles 6 are able to occupy extreme positions near the electrodes 3,4 and intermediate positions in between the electrodes 3,4. Each picture element 2 has an appearance determined by the position of the charged particles 6 between the electrodes 3,4. Electrophoretic media 5 are known per se from e.g. U.S. Pat. No. 5,961,804, U.S. Pat. No. 6,120,839 and U.S. Pat. No. 6,130,774 and can e.g. be obtained from E Ink Corporation. As an example, the electrophoretic medium 5 comprises negatively charged black particles 6 in a white fluid. When the charged particles 6 are in a first extreme position, i.e. near the first electrode 3, as a result of the first potential being e.g. 15 Volts larger than the second potential, the appearance of the picture element 2 is e.g. white. When the charged particles 6 are in a second extreme position, i.e. near the second electrode 4, due to a potential difference between the first and the second electrode of opposite polarity, i.e. −15 Volts, the appearance of the picture element 2 is black. When the charged particles 6 are in one of the intermediate positions, i.e. in between the electrodes 3,4, the picture element 2 has one of the intermediate appearances, e.g. light gray, middle gray and dark gray, which are gray levels between white and black. The drive means 100 are able to control for each picture element 2 the potentials, thereby being able to change the position of the particles 6. The monitoring means 101 are able to generate for each picture element 2 actual position information indicative for the position of the particles 6. The monitoring means 101 have electrical means 102 which are able to generate for each picture element 2 the actual position information based on an electrical property of the respective picture element 2. The control means 103 are able to control for each picture element 2 the drive means 100 in dependence of the actual position information and the image information to reduce a difference between the actual position of the particles 6 and the position of the particles 6 corresponding to the image information.

As an example, the particles 6 in a picture element 2 occupy a position corresponding to an actual appearance of the picture element 2 which is light gray. The monitoring means 101 generate actual position information indicating that the picture element 2 is light gray. In this example, the picture appearance, being the appearance of the picture element 2 determined by the position of the particles 6 corresponding to the image information, is dark gray. To reduce the difference between the actual appearance and the picture appearance, the control means 101 control the drive means 100 to have the first and the second electrode 3,4 receive a first potential which is e.g. 15 Volts smaller than the second potential for an interval depending on the change of appearance which has to be achieved. As a result, the difference between the actual appearance and the picture appearance is reduced, in this case the picture element 2 has become darker. Preferably, the monitoring means 101 generate again actual position information, used by the control means, etc. resulting in a further reduction of the difference between the actual appearance and the picture appearance.

In an embodiment the electrical means 102 are able to generate for each picture element 2 the actual position information based on the electrical resistance between the first and the second electrode 3,4. FIG. 3 shows an example of the relation between the position X of the particles 6 and the electrical resistance R, in the case that the particles have a higher resistance than the fluid. When the particles 6 occupy the first extreme position, denoted by EP1, corresponding to a picture element 2 having a white appearance, denoted by W, the value of the electrical resistance is R1. When the particles 6 occupy the second extreme position, denoted by EP2, corresponding to the picture element 2 having a black appearance, denoted by B, the value of the electrical resistance is R1. The intermediate positions are denoted by IP, e.g. position P1 corresponds to the picture element 2 having a light gray appearance, denoted by LG, and a value R2 of the electrical resistance, position IP2 corresponds to the picture element 2 having a middle gray appearance, denoted by MG, and a value R3 of the electrical resistance and position P3 corresponds to the picture element 2 having a dark gray appearance, denoted by DG, and a value R2 of the electrical resistance. When the particles 6 occupy one of the extreme positions the electrical resistance is relatively large compared to the particles 6 occupying one of the intermediate positions. As an example the actual position of the particles 6 in a picture element is position EP1, corresponding to the picture element 2 having a white appearance and a value of the electrical resistance being R1. The electrical means 101 generate actual position information from the value R1 of the resistance indicating that the picture element 2 is white. In this example, the picture appearance is light gray, denoted by LG. Then the control means 101 control the drive means 100 to reduce the difference between the actual appearance and the picture appearance. As a result, the difference between the actual appearance and the picture appearance is reduced and the picture element 2 has become darker.

In another embodiment the electrical means 102 are able to generate for each picture element 2 the position information based on the electrical resistance between the first and the second electrode 3,4 and a function of the derivative of the resistance with respect to the position of the particles 6 of the respective picture element 2. As an example refer to FIG. 3. The relation between the resistance R and the position X of the particles 6 shows that one value of the resistance may relate to two different positions of the particles 6. In this example, the particles 6 occupying position IP1 corresponding to a picture element 2 having a light gray appearance result in the same electrical resistance, R2, as the particles 6 occupying position IP3 corresponding to a picture element 2 having a dark gray appearance. FIG. 3 also shows that monitoring of the actual position of the particles by means of the electrical resistance can be improved by the combination of the resistance R and a function of the derivative of the resistance R with respect to the position of the particles 6. In this example, for the position of the particles 6 corresponding to the picture element 2 having a light gray appearance, the derivative of the resistance with respect to the position of the particles 6 has a negative sign, whereas for the position of the particles 6 corresponding to a picture element 2 having a dark gray appearance the derivative of the resistance with respect to the position of the particles 6 has a positive sign.

In another embodiment the electrical property is the capacitance between the first electrode 3 and the second electrode 4. As an example, see FIG. 4, the second substrate 9 has for each picture element 2 the first electrode 3 and the second electrode 4. The electrical means 102 are able to determine the capacitance between the first electrode 3 and the second electrode 4. FIG. 5 shows an example of the relation between the position X of the particles 6 and the capacitance C, in the case that the particles 6 have a higher dielectric constant than the fluid. When the particles 6 occupy the first extreme position, corresponding to a picture element 2 having a white appearance, the value of the capacitance is C1. When the particles 6 occupy the second extreme position, also corresponding to the picture element 2 having a white appearance, the value of the capacitance is C1. The intermediate positions are denoted by IP, e.g. position IP1 corresponds to the picture element 2 having a light gray appearance, and a value C2 of the capacitance, position IP2 corresponds to the picture element 2 having a dark gray appearance, and a value C3 of the capacitance and position IP3 corresponds to the picture element 2 having a black appearance, and a value C4 of the capacitance. When the particles 6 occupy one of the extreme positions the capacitance is relatively low compared to the particles 6 occupying one of the intermediate positions. The electrical means 102 may be able to determine the capacitance C from the registration of the time required to reach a predetermined voltage difference between the first and the second electrode 3,4 as a consequence of the application of a predetermined current between the first and the second electrode 3,4. It is favorable, if the predetermined current is present only for a relatively short time, as a then the position of the particles 6 is substantially unchanged.

In another embodiment the electrical means 102 are able to generate for each picture element 2 the position information based on the capacitance between the first and the second electrode 3,4 and a function of the derivative of the capacitance with respect to the position of the particles 6 of the respective picture element 2. As an example refer to FIG. 5. The relation between the capacitance C and the position X of the particles 6 shows that one value of the capacitance may relate to two different positions of the particles 6. FIG. 5 also shows that monitoring of the actual position of the particles by means of the capacitance can be improved by the combination of the capacitance C and a function of the derivative of the capacitance C with respect to the position of the particles 6, similarly as is described with the resistance R and the derivative of the resistance.

In another embodiment shown in FIG. 6, the second substrate 9 has the first electrodes 3, the second electrodes 4 and, furthermore, the second substrate 9 has for each picture element 2 a third electrode 7 for receiving a third potential. The part of the picture element 2 related to the second and the third electrodes 4,7 may act as reservoir for the particles 6, shielded from the viewer. The appearance of the picture element 2 is determined by the position of the particles 6 between the first and the second electrodes 3,4. The three electrodes 3,4,7 determine the number of the particles 6 present between the first and the second electrode 3,4 and the position of the particles 6 between the first and the second electrode 3,4. The electrical means 102 are able to generate for each picture element 2 the actual position information based on the capacitance C between the first electrode 3 and the second electrode 4 and a further capacitance between the second electrode 4 and the third electrode 7. In a similar way as described above, the electrical means 102 may be able to determine the further capacitance.

1. An electrophoretic display panel (1) for displaying a picture corresponding to image information, comprising:
an electrophoretic medium (5), comprising charged particles (6) in a fluid;
a plurality of picture elements (2);
a first and a second electrode (3,4) associated with each picture element (2) for receiving a first and a second potential, respectively,
drive means (100);
monitoring means (101); and
control means (103),
the charged particles (6) being able to occupy a position between the electrodes (3,4), the drive means (100) being able to control for each picture element (2) the potentials, thereby being able to change the position particles (6) based on the image information,
the monitoring means (101) being able to generate for each picture element (2) actual position information indicative for the actual position of the particles (6), and
the control means (103) being able to control for each picture element (2) the drive means (100) in dependence of the actual position information and the image information to reduce a difference between the actual position of the particles (6) and the position of the particles (6) corresponding to the image information, characterised in that
the monitoring means (101) comprise electrical means (102) able to generate for each picture element (2) the actual position information based on an electrical property of the respective picture element (2).

2. A display panel (1) as claimed in claim 1 characterized in that the electrical means (102) are able to generate for each picture element (2) the actual position information based on an electrical resistance between the first and the second electrode (3,4).

3. A display panel (1) as claimed in claim 1 characterized in that the electrical means (102) are able to generate for each picture element (2) the actual position information based on an electrical resistance between the first and the second electrode (3,4) and a function of a derivative of the resistance with respect to the position of the particles (6) of the respective picture element (2).

4. A display panel (1) as claimed in claim 3 characterized in that the function is a sign function.

5. A display panel (1) as claimed in claim 1 characterized in that the electrical means (102) are able to generate for each picture element (2) the actual position information based on a capacitance between the first and the second electrode (3,4).

6. A display panel (1) as claimed in claim 1 characterized in that the electrical means (102) are able to generate for each picture element (2) the actual position information based on a capacitance between the first and the second electrode (3,4) and a function of a derivative of the capacitance with respect to the position of the particles (6) of the respective picture element (2).

7. A display panel (1) as claimed in claim 6 characterized in that the function is a sign function.
